(19) United States
(12) Patent Application Publication
(10) Pub. No.: US 2020/0030879 A1
(43) Pub. Date: Jan. 30, 2020

(54) LASER-ASSISTED ADDITIVE MANUFACTURE OF OPTICS USING THERMALLY CURABLE MATERIALS

(71) Applicant: Arizona Board of Regents on Behalf of the University of Arizona, Tucson, AZ (US)

(72) Inventors: Rongguang Liang, Tucson, AZ (US); Zhihan Hong, Tucson, AZ (US)

(73) Assignee: Arizona Board of Regents on Behalf of the University of Arizona, Tucson, AZ (US)

(21) Appl. No.: 16/484,310

(22) PCT Filed: Feb. 16, 2018
(86) PCT No.: PCT/US18/00066

§ 371 Date: Aug. 7, 2019

Related U.S. Application Data
(60) Provisional application No. 62/459,738, filed on Feb. 16, 2017.

(51) Int. Cl. B22F 3/105; H01S 3/00

(52) U.S. Cl. CPC B22F 3/1055; G02B 1/043; H01S 3/0007

(57) ABSTRACT

A system and method for printing a transparent object with an additive manufacture printer. The system includes a stage on which the object is to be produced, a dispenser coupled to a source of thermally-curable optical material positioned to deposit the thermally-curable optical material at a position on the stage, an ultrafast laser configured to direct radiation having a wavelength in the range 800 nm-2000 nm to the position, and at least one mechanism to cause relative movement between the stage and the dispenser, and relative movement between the stage and the laser.

### CROSS-REFERENCE TO RELATED APPLICATION

The present application in the U.S. National State Application of PCT Application No. PCT/US18/00066, filed Feb. 16, 2018, which relates and claims priority to U.S. Provisional Application No. 62/459,738 filed Feb. 16, 2017, the entirety of each of which is hereby incorporated by reference.

### BACKGROUND OF THE INVENTION

### 1. Field of the Invention

Additive manufacture of optics, in particular, laser-assisted additive manufacture of optics made of thermally curable optical materials.

### 2. Description of Related Art

Additive manufacturing (AM), also known as three-dimensional (3D) printing, refers to processes used to create 3D objects by the successive layering of material under computer control. AM technologies are widely used in the automotive, aerospace, military, dental, and medical industries. While there have been tremendous developments in AM, the 3D printing of optics is lagging due to its unique requirements. Although a number of commercially sold 3D printers can print transparent components, post processing that is typically needed to create smooth surfaces cannot control the surface shape and surface roughness to a sufficient degree. None of these commercially sold 3D printers can truly print optical elements with good surface quality for imaging applications.

Freeform optics is a recent, emerging field being developed to meet the increasing demands created by the high performance and ultra-compact optical imaging systems critical to consumer and medical applications, such as mobile phones, head mounted displays, and ultrathin endoscopes. When compared to traditional optics, freeform optics offer a number of advantages; however, a precision freeform optical element is much more complicated to fabricate and test than a traditional optical element. Ultra-precision single point diamond turning is capable of producing high quality surface finishes on the order of nanometers, while meeting tight form tolerances on the order of micrometers. However, it is a very time-consuming process and the prototyping cost is high. Fabrication is one of the major issues preventing freeform optics from realizing rapid commercial adoption, with current options incapable of complex freeform optics or prohibitively expensive and time-consuming.

Prior art systems for 3D printing of transparent material include the “printoptical” technology by Luxexcel Group B. V., stereolithography (SLA), multi-jet modeling (MJM), and polyjet printing. Recently Nanoscribe GmbH has developed a new technique for printing micro-optical elements using a two-photon technique.

SLA uses a photopolymer resin cured by an ultraviolet (UV) light. The photopolymer is solidified layer-by-layer to create a product. Due to the curing process used, visible layers remain in the product. MJM uses a jetting technology and a wax support material, with a product printed layer-by-layer and the support material is then melted away. Polyjet 3D printing can work with a wide range of materials: layers of liquid photopolymer are layered and cured using UV light, with the capability to form complex geometries. All three techniques and the commercial systems, however, were developed to print non-transparent components. Although post-processing like sanding and grit blastering can increase transparency, the surface roughness exceeds the demands of optical applications and, most importantly, the surface shape after post-processing cannot be controlled.

Nanoscribe's Photonic Professional GT uses multiphoton polymerization with direct laser writing, and was developed to produce complex photonics structure—rather than optical imaging. Its major problem for printing optical components is the small field of view of the scanning microscope objective, which means only very small optics can be realized. For optics larger than a few hundred microns, the gaps between the field of view may be obvious and unsuitable for imaging applications.

Luxexcel's proprietary “printoptical” technology can 3D print transparent products without visible layering using a UV-curable acrylic. Droplets are jetted and merged before being cured. This is the only printing technique that can manufacture regular-size optical elements. Due to the relatively large surface shape error and low surface quality, however, the printed optical elements are not suitable for imaging applications and are mostly used for illumination.

All of the above commercial systems use UV curing, either through a standard UV polymerization process or two-photon polymerization process. One limitation of the current UV curing systems is the resultant lens material appears yellowish.

Optical silicone is one material which is typically used in LED lighting and other applications. Compared to UV curable materials, it has a number of advantages: strong UV stability, non-yellowing, and high transmission. Optical silicone is particularly suitable for optical imaging applications. A number of methods have been reported to fabricate optics using optical silicones, including lithographic methods, surface tension driven methods, embossing methods, hanging methods, and confined sessile drop technique. However those methods have some common issues: (1) they are limited to simple, small scale optics; (2) they are relatively slow; and (3) they cannot control the freeform shape to meet the specifications. A moving needle method was developed to partially change the lens shape, but it cannot control the lens shape accurately. Printing using a passive droplet dispenser has been investigated to fabricate lenses from optical silicone as well, but the reported method cannot control the lens shape adequately.

The major limitation of the reported methods in fabricating optics from optical silicone is that there is no effective method to control the lens shape. The lens shape relies on the formation of liquid droplets, which is the interplay of viscous drag, surface tension, capillary forces and gravitational forces. Another limitation is that as the entire optics is heated to solidify the component after the shape is formed, it is a time consuming process which may also introduce errors when the optics is large.

Therefore, there is a need for improved techniques for additive manufacturing of optics, including techniques of additive freeform optics manufacturing (AFOM), which can fabricate freeform optics rapidly, accurately, and efficiently.

### SUMMARY OF THE INVENTION

Aspects of the present invention are directed to apparatus and methods for precision additive optics manufacturing, including additive freeform optics manufacturing (AFOM) using optical silicones, optical adhesives, and other thermal curable materials (such as sol-gel, silicone hydrogel), these aspects including ultrafast infrared (IR) lasers and/or pulse IR radiation. The inventors have determined that getting heat into the optical material quickly is critical to solidifying the material quickly and reducing cycle times. Instead of curing the entire optical element using oven or other heating methods, an ultrafast IR laser is used to locally solidify the optical materials to control the lens shape accurately. Ultrafast laser radiation can offer advantages in processing the material, due to the high peak intensity achieved in the focal region which allows for curing of optical material and the brief duration of the laser-material interaction can potentially offer a negligible heat-affected zone. Aspects of the present invention are capable of forming freeform optics and other complex optics that are inaccessible with conventional processes.

It is to be appreciated that, depending on the material chemistry, curing using IR radiation may increase temperature resistance, chemical resistance and improve material strength.

According to some aspects of the invention, apparatus and methods for producing optics comprise an ultrafast IR laser or ultrafast laser radiation in combination with in situ metrology.

According to some aspects of the invention, metrology may be used to measure a printed surface in real time and provide feedback to a print system to fine tune the printing process.

In one embodiment, the invention is an additive manufacture printer for printing a transparent object. The additive manufacture printer includes a stage on which the object is to be produced and a dispenser coupled to a source of thermally-curable optical material positioned to deposit the thermally-curable optical material at a position on the stage. The printer also includes an ultrafast laser configured to direct radiation having a wavelength in the range 800 nm-2000 nm to the position, and at least one mechanism to cause relative movement between the stage and the dispenser, and relative movement between the stage and the laser.

In another embodiment, the additive manufacture printer includes a stage on which the object is to be produced, a dispenser coupled to a source of thermally-curable silicone positioned to deposit the thermally-curable optical material at a position on the stage, and an ultrafast laser configured to direct radiation having a wavelength in the range 800 nm-2000 nm to the position. The printer also includes at least one processor coupled to at least one of the stage, the dispenser, and the laser. The processor is programmed to control at least one of a position on the stage at which the thermally-curable optical material is to be deposited, an amount of thermally-curable optical material to be deposited, a position to which the IR-radiation is to be directed, a beam steering apparatus, and a parameter of the laser radiation. The printer additionally includes a metrology apparatus configured to measure a parameter of the object and provide the measured parameter to the processor The at least one processor has a modeling and control software module to compare the measured parameter to a design target and modify at least one of the position on the stage on which the thermally-curable optical material is to be deposited, the amount of thermally-curable optical material to be deposited, the position to which the IR-radiation is to be directed, the beam steering apparatus, and the parameter of the laser radiation.

In another embodiment, the invention is a method for printing a transparent object. The method includes the steps of: (i) providing an additive manufacture printer having a stage on which the object is to be produced, a dispenser coupled to a source of thermally-curable optical material positioned to deposit the thermally-curable optical material at a substrate on the stage, an ultrafast laser, and at least one mechanism to cause relative movement between the stage and the dispenser, and relative movement between the stage and the laser; (ii) dispensing, via the dispenser, thermally-curable optical material on a substrate on the stage; (iii) distributing the thermally-curable optical material substantially uniformly over the substrate; (iv) directing, via the ultrafast laser, radiation having a wavelength in the range 800 nm-2000 nm to the substrate; (v) solidifying at least a first portion of the thermally-curable optical material to generate a cured layer.

The term “ultrafast” is defined herein to mean nanosecond, picosecond, and femtosecond.

The term “transparent” is defined herein to mean capable to transmitting at least a portion of radiation incident thereon, the radiation being in the spectrum up to and including infrared wavelengths and ultraviolet wavelengths, including the visible band and all other bands in the said spectrum. In some instances, the transmission of the radiation is at least 50% transmission of at least some wavelengths in the spectrum, and in some instances the transmission of the radiation is at least 80% of at least some wavelengths in the spectrum.

The term “degree of cure” is defined herein to refer to a location on a continuum between the liquid phase and the solid phase of a thermally-curable material which is dependent on, for example, time and heat applied to the thermally-curable material.

### BRIEF DESCRIPTION OF THE DRAWINGS

The present invention will be more fully understood and appreciated by reading the following Detailed Description in conjunction with the accompanying drawings, in which:

FIG. 1 is a schematic diagram of a process for AM in accordance with an embodiment;

FIG. 2 is a block diagram showing the elements of an printing system according to an embodiment;

FIG. 3 depicts an exemplary process for fabricating a lens from thermally curable optical material in accordance with an embodiment;

FIG. 4 depicts lenses printed with a system using Dow Corning Sylgard 184 Silicone Elastomer in accordance with an embodiment;

FIG. 5 is a graph showing the absorption properties of selected optical silicones in accordance with an embodiment;

FIG. 6 is a schematic diagram of a print head with an IR focusing lens and chromatic confocal objective in accordance with an embodiment;

FIG. 7 is a schematic diagram of a lens analysis for planning the printing process in accordance with an embodiment;

FIG. 8 is a schematic diagram of a print head with an IR focusing lens and dispenser for drop-on-demand printing in accordance with an embodiment;

FIG. 9 is a schematic diagram of an exemplary process for fabricating a lens from thermal curable material using projection method;

FIG. 10 is a schematic diagram of an exemplary process for fabricating a lens using a lithographic printing process;

FIG. 11 is a schematic diagram of an exemplary process for printing a bi-curved lens; and

FIG. 12 is a schematic diagram of an exemplary process for printing lens with pre-formed substrate.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific example, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

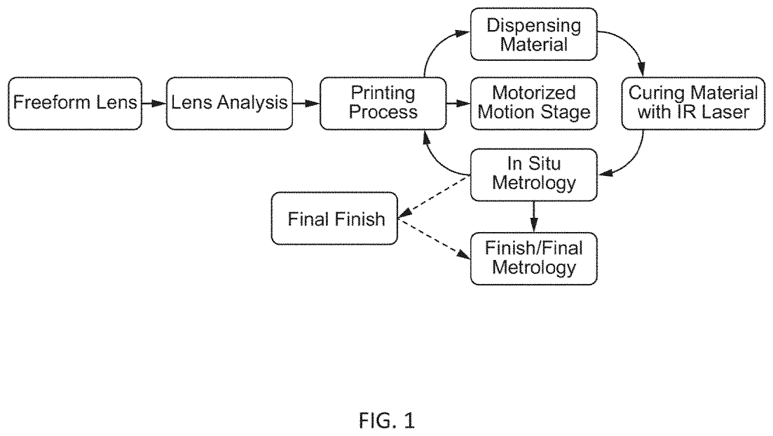

Referring first to FIG. 1, there is shown a schematic diagram of the proposed AM process. After a lens is designed, it is imported to the modeling software from the optical design software. The modeling software will analyze the design and the specifications, and then layout the printing process to achieve a lens of a defined final shape and defined intermediate shapes. The printing process will instruct the dispenser to distribute an appropriate amount of materials to a substrate located on a stage. The focused IR laser beam is used to heat and solidify the material locally to the defined shape. Deposition location and cure location may be facilitated by moving the print head relative to the stage.

In some embodiments, in situ metrology will measure a cured surface in real time and provide feedback to the printing process. If there is deviation from a defined intermediate shape, the printing process will be fine-tuned to compensate for the deviation. This is a recurrent process until the lens meets the specifications. If the final measurement result (e.g., lens shape or surface roughness) still does not meet the specifications, an ultrafast IR laser may be applied to locally modify the surface shape and roughness.

Key advantages of the proposed techniques include: (1) accurate fabrication of complex freeform optics with high surface quality; (2) ability to print in three printing modes (layer-by-layer, drop-on-demand, and lithographic modes); and (3) lenses are typically strong UV stabile, non-yellowing, and high transmission.

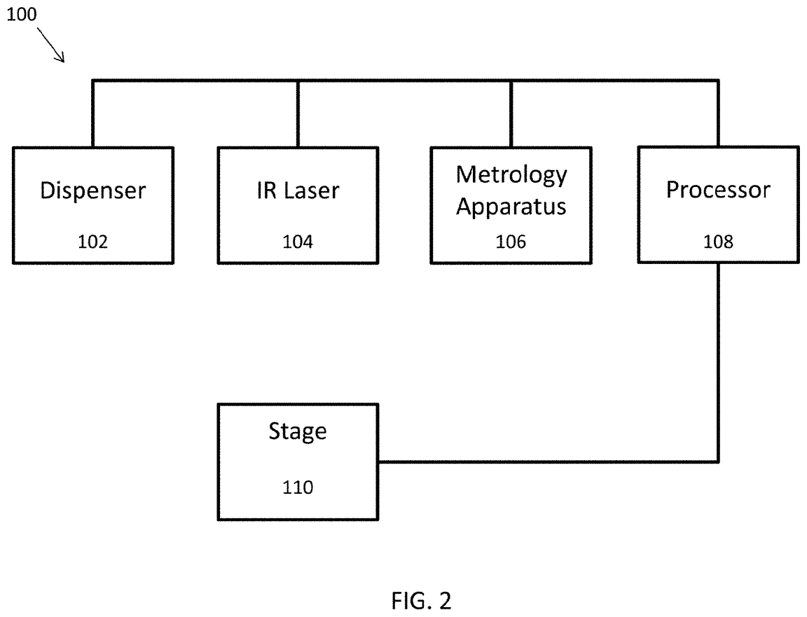

Turning now to FIG. 2, there is shown a block diagram showing the elements of an example of an embodiment of a printing system 100 according to aspects of the present invention. The system 100 comprises a material dispenser 102 to deposit material (i.e., thermal curable material) constituting the optic to be produced, an IR laser 104 to cure the material, and a stage 110 or other means to produce relative movement between the dispenser 102 and/or the laser 104, and the lens to be produced. For example, a stage 110 may be configured to move the product while it is being produced to control the location at which the material is dispensed and the locations at which the material is cured. Optionally, a metrology apparatus 106 to measure the product while it is being produced and/or after it is produced may be included.

A processor 108 is coupled to the dispenser 102, the laser 104 and the stage 110 to receive information therefrom and to provide control signals thereto. The processor 108 also controls deposition and curing of the material. The processor 108 may be additionally coupled to the metrology apparatus 106 to measure a product during manufacture. Optionally, as described in greater detail below, a system 100 may comprise a modeling and control software module to compare the measured results to the design target, and modify the deposition (e.g., amount and location of material) and/or curing process (e.g., the laser parameters) to achieve the design target.

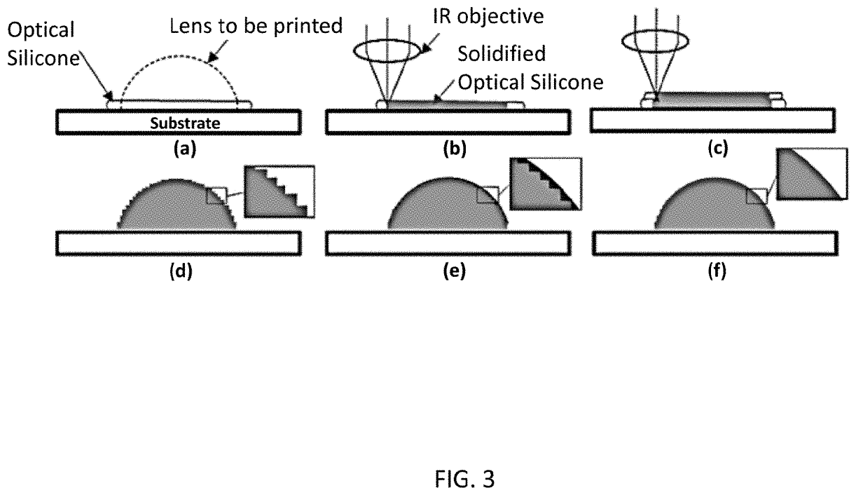

Referring to FIG. 3, there is shown an example of a process for fabricating a lens from thermally curable optical material according to aspects of the present invention in which material is deposited to form a layer which is cured by radiation from an ultrafast IR laser. At the first step, shown in image (a) of FIG. 3, the material is dropped on the substrate. The amount or volume of the material deposited on the substrate depends on the desired thickness of the layer and lens size. After the material flows uniformly over the substrate or on the solidified lens surface to form a layer of cured material as shown in image (a) or image (c) of FIG. 3, the focused, ultrafast laser beam will solidify the material in high speed to form the shape of each layer (shown in image (b) and image (c) of FIG. 3). By repeating the steps shown in image (a) and image (b) of FIG. 3, it is possible to form the lens shape as shown in image (d) of FIG. 3. The unsolidified material is spun off or cleaned using another approach.

Due to the layer-by-layer curing process, steps between each layer may be formed (as shown in image (d) of FIG. 3). To smooth the lens surface, a relatively large amount of material may be applied to the lens surface to fill the steps between each layer (as shown in image (e) of FIG. 3). The amount or volume of material applied to the lens surface is large relative to the quantity of material deposited on the substrate to form the lens layers. The applied material is then cured, for example, with pulsed or continuous wave IR laser (shown in image (f) of FIG. 3). One example of a material to be used is thermal curable silicone (e.g., MS-1002 available from Dow Corning). Another option for smoothing between the layers is applying a quantity of material over the entirety or a portion of the outer surface of layered lens and heating the quantity of material to cure it. Depending on factors such as the material and the thickness of the layer, the quantity of material can be cured by heat of temperatures within the range of 150° C.-500° C. The heat can be applied by heat from surrounding air or by placing the lens in a bath of suitably hot water to cure the quantity of material.

Although a system using a focused beam was described above, it is to be appreciated that rather than a focused (i.e., point-by-point) curing process, the pulsed laser light may be projected (i.e., using a projector lens system) over an entire layer (or a fraction of a layer) such that the entire layer (or the fraction of a layer) is cured using one or more pulses. Also, although the above techniques use deposition of a layer or drop-on-demand prior to curing, it is also possible to provide a tank of liquid material (e.g., silicone) and to cure a layer of the liquid material (e.g., silicone) in a point-by-point or projection manner to produce the layers of a lens.

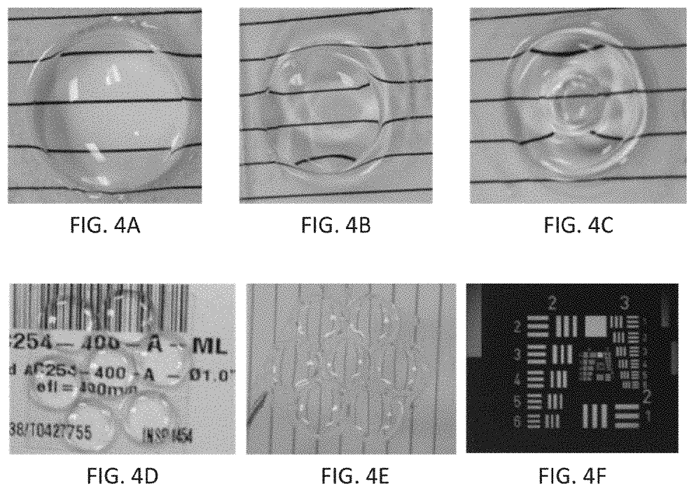

Turning now to FIG. 4, there are shown examples of printed lenses printed with a system according to aspects of the preset invention using Dow Corning Sylgard 184 Silicone Elastomer. Image (a) of FIG. 4 illustrates a simple plano-convex lens. Image 4(b) illustrates a plano-concave lens (FIG. 4(b)). Image (c) illustrates an example of a freeform lens (i.e., a donut lens). Additional freeform optics, a plano-convex lens array and a plano-concave lens array are shown in image (d) and image (e) of FIG. 4, respectively. Image 4(f) illustrates a USAF resolution target captured with the printed lens in image (a) of FIG. 4.

Further details regarding examples of printing systems according to aspects of the present invention are given below.

The material used to form a cured optic may comprise any IR-curable suitable material. One example of such a material is MS-1002 available from Dow Corning Corporation of Midland, Mich. Although the figures depict optical silicone as the material, other thermally curable optical materials may be used. For example, in an alternative embodiment, DELO DUALBOND adhesive may be used and either thermally cured or UV cured.

A material dispenser 102 may comprise any suitable apparatus for depositing a selected amount of material on the stage 110. For example, the material dispenser 102 may be computer-controlled nScrypt's SmartPump dispenser. The smallest volume dispensed by this dispenser can be less than 100 picoliters. Again, the amount of material dispensed by the material dispenser 102 depends on the desired thickness of the layer and lens size.

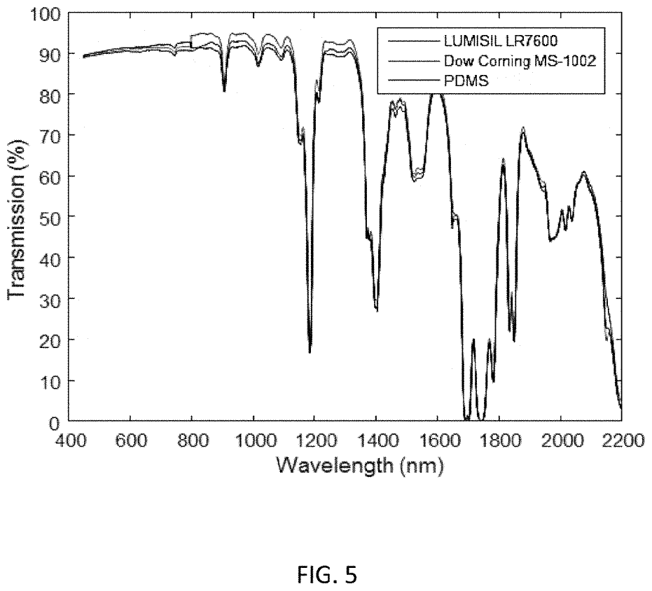

The pulsed, ultrafast IR laser 104 may be any suitable nanosecond laser or picosecond laser or femptosecond laser. Typically, the laser wavelength is between 800 nm and 2 micrometers, and selected to correspond to a band of strong absorption of the selected silicone material. Based on the absorption properties of the optical silicones as shown in FIG. 5, in one embodiment a 2 μm Mode-Locked Fiber Laser, AP-ML1-1950-01 from AdValue Photonics Inc. was used. It has the operating wavelength 1.95+/−0.05 μm, pulse width<3 ps, peak power>10 kW, and pulse repetition rate 20-40 MHz. In another embodiment, a CO2 laser may also be utilized.

Any suitable apparatus for achieving relative movement between the stage 110 and the dispenser 102, and/or relative movement between the stage 110 and the laser 104 may be used. The stage 110 may be a motion stage; alternatively, the dispenser 102 and laser 104 may be moved. In one embodiment, in which a motion stage is used, three Thorlabs's Compact Motorized Translation Stage MTS50-Z8 are used to accommodate the potential weight of a print head and to achieve adequate scan accuracy. The MTS50-Z8 stage has a travel range of 50 mm, resolution of 29 nm, and bidirectional repeatability of 1.6 μm, and a vertical load capacity of 4 kg.

An alternative to moving the stage 110 on which an optic is being printed is moving the print head (i.e., the laser 104 and/or dispenser 102) to achieve a displacement relative to the stage 110, for example, using a motorized translation apparatus. In such embodiments, a spot of light from the laser 104 and/or the dispenser 102 is scanned to dispense thermal curable material and/or to cure the material.

In addition to the above embodiments where the stage 110 and/or laser 104 are moved relative to one another, the laser beam may be steered (perhaps without movement of the stage 110 or laser 104) using a beam steering apparatus, for example, by using a galvo-scanner.

Any suitable technique for in situ measurement of an optic that is being manufactured may be used for metrology. In some embodiments, the measurement apparatus is an optical metrology apparatus 106. For example, the optical metrology apparatus 106 may use interferometric methods, deflectometric methods, and confocal methods. For example, in situ metrology apparatus 106 may include: (1) compact snapshot interferometric system, (2) deflectometric system, and (3) chromatic confocal system.

One example of a suitable apparatus is a chromatic confocal apparatus which is able to measure a surface with relative large slopes as well as discontinuous surfaces, and it can measure the surface roughness.

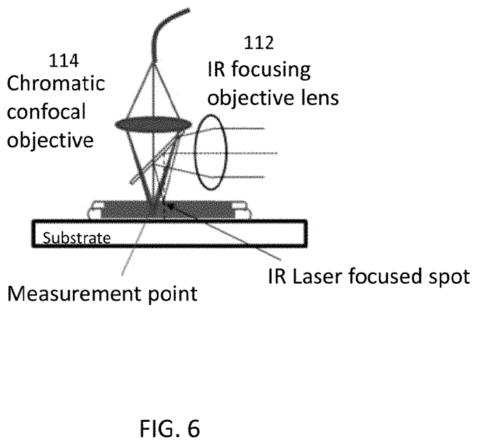

In some embodiments, the metrology apparatus 106 and deposition apparatus may be collocated to form a print head. Since the light can be delivered to the confocal probe through the fiber, the probe can be very compact. Such a configuration may be particularly suitable for in situ metrology in printing freeform optics. In some embodiments, the print head further comprises an objective lens 112 to focus the IR laser for curing the material, a material dispenser 102 to distribute the material, and a chromatic confocal objective 114 for measuring the surface shape and roughness. FIG. 6 illustrates one example of such an embodiment. For such an embodiment, the heating spot and the measurement spot are displaced slightly (e.g., 5-10 mm) so that the chromatic confocal probe can measure the cured region shortly after (e.g., 0.1 to 1.0 seconds) the region is solidified.

In some embodiments, the processor 108 to control the printing process (including deposition and curing) may be programmed to modify the printing process (i.e., modification or adding of one or more subsequent printing steps (e.g., layers)) based on a metrology measurement of previously deposited material (i.e., one or more previously deposited layers) to more accurately achieve a desired lens design.

A printer according to present invention may comprise a processor 108 configured to receive metrology information from an optical component being produced on a stage 110. The processor 108 can be programmed to comprise a modeling and control software module to determine heat distribution in the material and the curing of the material that would occur during a planned printing process, for example, using mathematical models. A model of the printing process is dependent at least in part on laser power and pulse duration, the numerical aperture of the objective that directs the laser light onto deposited layer of material, the smallest diameter of the solidified region, as well as the properties of the deposited material.

It will be appreciated that, in the course of the curing process, the thermal properties of the material undergo changes according to temperature and degree of cure and that such changes can be accounted for in a model of the curing process. For example, a model of the curing process may include modeling of the material's density, specific heat, and thermal conductivity as a function of degree of cure. It will be appreciated that a model of the curing process may account for shrinkage by modeling changes of density at solid and liquid states of the material as a function of degree of cure. It will also be appreciated that a model of the curing process may account for changes in the specific heat as a function of temperature and degree of cure.

### Establish a Printing Process

With a simulation model of heating and curing, a lens analysis model to plan the printing (i.e., deposition and curing) process so that the lens can be printed accurately can be obtained. Deposition and curing may occur using layer-by-layer printing approach or drop-on-demand (e.g., using droplets having diameters of less than 100 mircons) or lithographic approach or curing of the material in a tank of the material. For any of these processes, it is desirable to determine the amount of the material to distribute in each cycle, laser parameters, numerical aperture of the objective lens, and scanning speed, as well as the path of the print head, which determines the curing path.

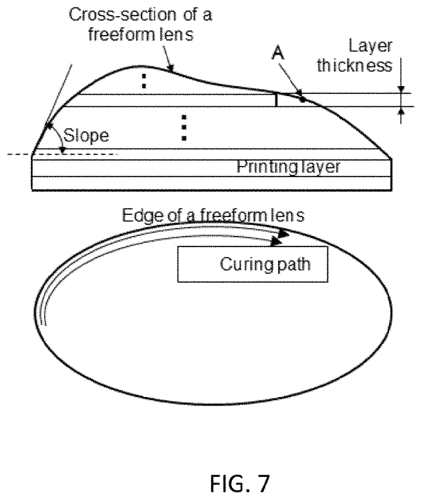

According to one example of a printing process, a first step is to analyze a lens to be made by calculating the slope of the surface at locations along its profile (as shown in FIG. 7).

The thickness of each layer of the printing process is determined by estimating the slope of the central point of each layer after curing (e.g., using a model of the printing process) such that the slope of the cured layer is the same as the slope at the same profile location on the profile of the lens to be made (for example, part A in FIG. 7).

To form a layer of the selected thickness, the amount of the material to be distributed in each cycle, the laser parameters, the numerical aperture of the objective lens, and the scanning speed of the laser are all determined. Further, to plan the printing process, the location to drop the material for each layer based on the lens shape so that the material can flow uniformly across the surface is determined using heating and curing modeling as set forth above. The curing path based on the lens shape typically begins with curing the edge of the lens first and then gradually to the center in an inward spiral.

The lens analysis and printing process planning for the other printing approaches (e.g., drop-on-demand and lithographic methods) are similar. It will be appreciated that in situ metrology as described herein, will provide feedback on each layer shortly after it is printed and permitting adjustment of each subsequent layer as described below.

### Improve the Performance with In Situ Metrology

In traditional optics fabrication, a part (while it is being manufactured) is periodically measured to ensure the part is printed to specification, either using a test plate or interferometer. However, in current commercial or research printing systems, no in situ metrology has been used to evaluate the printed surface during the printing process. Therefore, it is difficult to print the lens to specifications because there are many more factors which can impact the surface shape and surface roughness, compared to the traditional grinding and polish method.

According to an aspect of the present invention, a chromatic confocal microscope is used to perform metrologic measurements. Since a chromatic confocal microscope measures distance between a confocal probe and a surface under test, it can measure surface shape and surface roughness. A chromatic confocal microscope can also measure layer thickness by comparing the measurement results before and after a given layer is added. In addition, the probe can measure lens thickness which is one of the important parameters of the lens.

In some embodiments, the surface data will be measured after each layer is formed and will be available to determine whether the lens is fabricated to the expected immediate shape. Any deviation may be used to fine tune subsequent steps of the printing process, for example, to adjust the layer thickness, laser power or other parameters as set forth herein.

The measurement data of the final surface may be compared to the design specifications. If there is deviation from the specifications, additional material can be added and cured locally (i.e., less than a full layer) to ensure the lens is printed correctly. An alternative or additional approach is to locally heat the printed lens and melt the material until the lens meets the requirement as described in greater detail below.

### Drop-on-Demand, Projection, and Lithographic Printing Processes

Although the cure process model described above was discussed with reference to a layer-by-layer process, the heating and curing principles discussed apply to drop-on-demand and lithographic printing processes and curing of the material in a tank of the material.

In some instances, when printing more complex optics, for example, for an optic having discontinuous features (e.g., multiple lens arrays), drop-on-demand approach will be more effective because no material is needed between at least some features (e.g., between arrays).

Similar to the layer-by-layer technique, in the instance of drop-on-demand, a printing process is based on lens geometry. Laser parameters are selected to cure each droplet quickly once it reaches the substrate or the intermediate cured surface. A difference between planning a printing process using layers to form an optical surface as set forth above and planning a printing process using droplets to form an optical surface is that a model of a surface profile produced by droplets may include using finite element analysis of, both, the dynamic deformation of droplets during the drop process and the curing process of droplets.

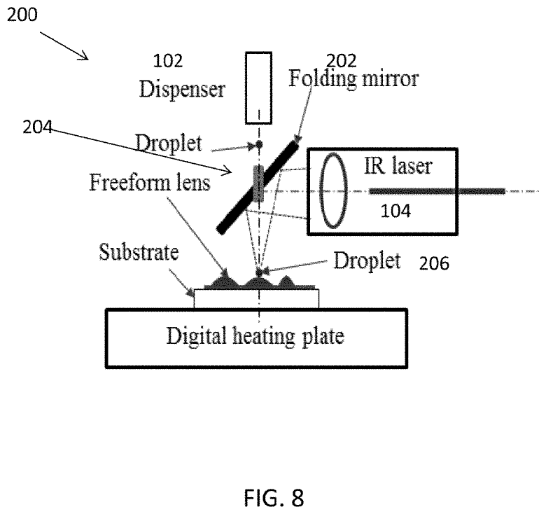

An example of a print head 200 to be used with drop-on-demand, is shown in FIG. 8. In drop-on-demand system, it is typically desirable to cure each droplet relatively quickly. In the print head shown in FIG. 8 achieves quick curing by including a folding mirror 202 with a hole 204 to allow a droplet 206 to reach the substrate, and an IR laser 104 to heat the droplet 206 directly at its focal point to facilitate fast curing.

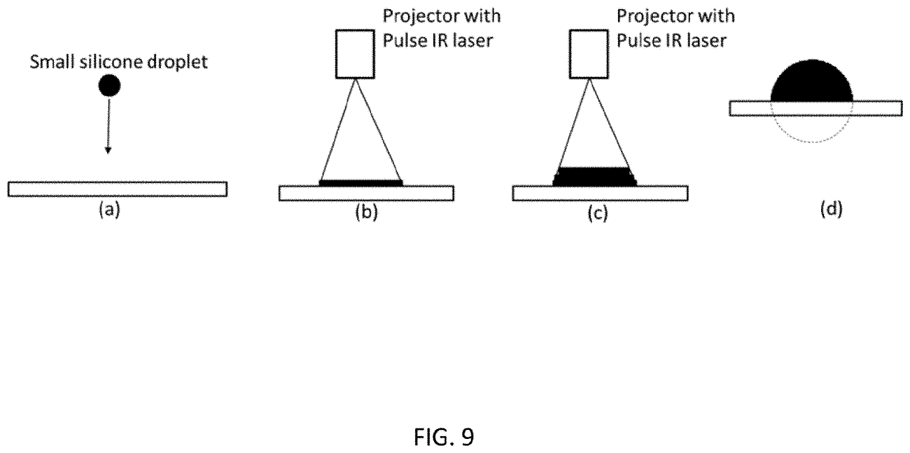

A schematic diagram of an example of a projection printing system is shown in FIG. 9. At the first step, shown in image (a) of FIG. 9, the material is dropped on the substrate. After the material flows uniformly over the substrate or on the solidified lens surface to form a layer of cured material as shown in image (b) or image (c) of FIG. 9, a digital projector projects an IR light pattern on the material to cure the material. By repeating the steps shown in image (b) and image (d) of FIG. 9, it is possible to form the lens shape as shown in image (d) of FIG. 9. The unsolidified material is spun off or cleaned using another approach.

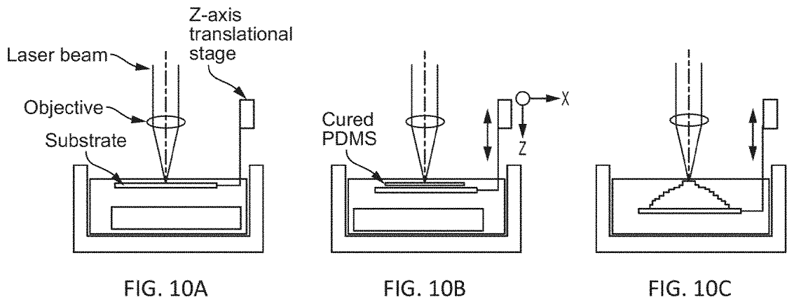

FIG. 10 is a schematic diagram of an example of a lithographic printing process. As shown in image (a) of FIG. 10, the substrate is attached to a translation stage that can be moved in the z-direction to adjust the thickness of each printed layer. The laser focal point is always at the top surface of the uncured material to cure the material. After the current layer is cured, the z-axis stage moves the substrate and cured layer down so that the new material will cover the cured layer uniformly. The laser will then cure the new layer to the predefined shape. The process is repeated until the lens is printed. The curing thickness is controlled by the z-axis stage and printing parameters. Another aspect of the present invention is methods and apparatus facilitating the printing of bi-curved optics. Printing of bi-curved lenses, such as bi-convex, bi-concave, or concave-convex freeform lenses can be challenging because there is no flat surface to support the lens during printing.

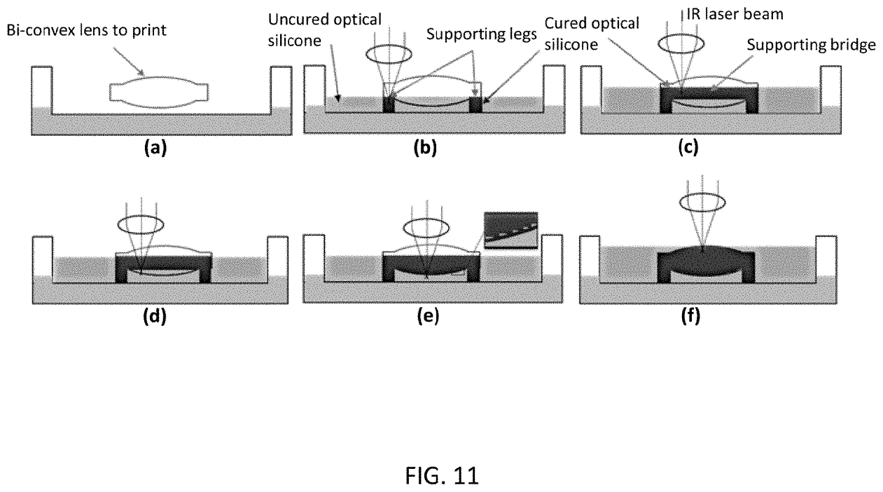

A schematic diagram of an approach to printing a bi-curved lens is shown in FIG. 11, images (a)-(e). To print the bi-convex lens (the lens in image (a)), a tray is provided. Two supporting legs or one supporting cylinder is provided (image (b)). The legs or cylinder may be printed or placed into the tray. It is to be appreciated that the supporting features may be used as the mounting features for the resultant lens; however the mounting features may be removed in a post-printing step.

As shown in image (c) of FIG. 11, a supporting bridge is printed having a thickness smaller than the lens thickness. It will be appreciated that it may be advantageous that the bridge has the same diameter as the final lens diameter.

After the bridge is printed, material may be added under the bridge by solidifying the material. For example, the material may be solidified layer-by-layer as shown in image (d) of FIG. 11 until forming an outer lens surface (image (e)). Other solidification patterns may be used.

Where layers are used, as discussed above, there may be discontinuities (i.e., steps) between layers. Steps may be filled-in using the approach described above. As shown in image (f) of FIG. 11, material may be added and cured above the bridge by adding and curing material layer-by-layer.

It will be appreciated that in the illustrated method, laser parameters and scanning speed to print the lens surface under the bridge where the lens surface is immersed in the uncured silicone. Simulation to model the curing process in a manner similar to manner described above will be used to control the laser parameters and scanning speed. During printing, optical material may be added continuously; however, discrete additive steps may be performed. While the material added below the bridge is executed using an immersion technique as describe above, adding of material above the bridge may be added using an immersion technique or another suitable technique (e.g., a technique as described herein).

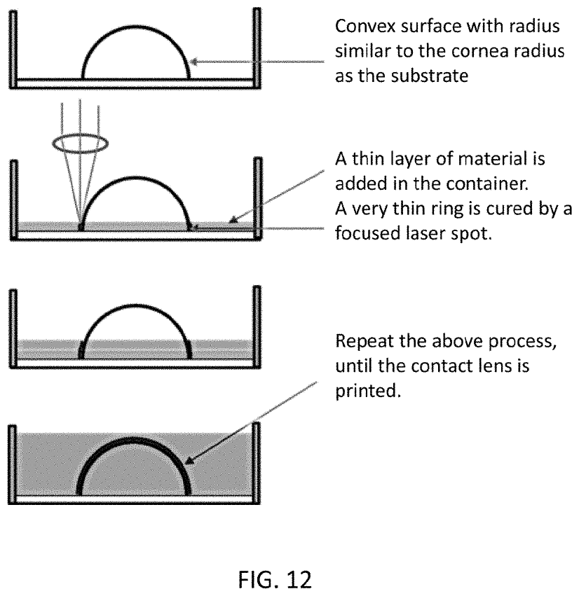

A schematic diagram of an approach to printing a lens, such as a contact lens, on the pre-formed substrate is shown in FIG. 12. Many thin lenses, such as contact lenses, have both surfaces curved. Instead of printing the lens using the method in FIG. 11, the thin curved lens can be fabricated on the pre-formed substrate. The printing process is similar to the layer-by-layer process in FIG. 3. Contact lenses, flexible thin lenses placed directly on the surface of the eye, are generally composed of silicone hydrogel. In some embodiments of contact lenses, a polar group is added to the silicone hydrogel to serve as a wetting agent or an agent to increase oxygen permeability without changing the structure of the silicone hydrogel. As such, flexible contact lenses can be printed according to the layer-by-layer process shown in FIG. 3.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. An additive manufacture printer for printing a transparent object, comprising:
a stage on which the object is to be produced;
a dispenser coupled to a source of thermally-curable optical material positioned to deposit the thermally-curable optical material at a position on the stage;
an ultrafast laser configured to direct radiation having a wavelength in the range 800 nm-2000 nm to the position; and
at least one mechanism to cause relative movement between the stage and the dispenser, and relative movement between the stage and the laser.

2. The printer of claim 1, wherein the radiation has a wavelength in the range 1000 nm-2000 nm.

3. The printer of claim 1, wherein the ultrafast laser is one of a picosecond laser and a femptosecond laser.

4. The printer of claim 1, wherein the mechanism to cause relative movement comprises one of a translation stage and a galvo-scanner.

5. The printer of claim 1, wherein the laser comprises a focusing lens to produce a focused spot at the position.

6. The printer of claim 1, wherein the thermally-curable optical material is silicone.

7. An additive manufacture printer for printing a transparent object, comprising:
a stage on which the object is to be produced;
a dispenser coupled to a source of thermally-curable optical material positioned to deposit the thermally-curable optical material at a position on the stage;
an ultrafast laser configured to direct radiation having a wavelength in the range 800 nm-2000 nm to the position;
at least one processor coupled to at least one of the stage, the dispenser and the laser, the processor programmed to control at least one of a position on the stage at which the thermally-curable optical material is to be deposited, an amount of thermally-curable optical material to be deposited, a position to which the IR-radiation is to be directed, a beam steering apparatus, and a parameter of the laser radiation; and
a metrology apparatus configured to measure a parameter of the object and provide the measured parameter to the processor,
the at least one processor having a modeling and control software module to compare the measured parameter to a design target and modify at least one of the position on the stage on which the thermally-curable optical material is to be deposited, the amount of thermally-curable optical material to be deposited, the position to which the IR-radiation is to be directed, the beam steering apparatus, and the parameter of the laser radiation.

8. The printer of claim 7, wherein the metrology apparatus is an optical sensor.

9. The printer of claim 8, wherein the optical sensor comprises a chromatic confocal apparatus.

10. The printer of claim 7, further comprising at least one mechanism to cause relative movement between the stage and the dispenser, and relative movement between the stage and the laser.

11. The printer of claim 7, further comprising a deposition apparatus.

12. The printer of claim 11, wherein the metrology apparatus and the deposition apparatus are collocated, forming a print head.

13. The printer of claim 12, wherein the print head comprises an objective lens configured to focus IR laser.

14. A method for printing a transparent object, comprising the steps of:
providing an additive manufacture printer having a stage on which the object is to be produced, a dispenser coupled to a source of thermally-curable optical material positioned to deposit the thermally-curable optical material at a substrate on the stage, an ultrafast laser, and at least one mechanism to cause relative movement between the stage and the dispenser, and relative movement between the stage and the laser;
dispensing, via the dispenser, thermally-curable optical material on a substrate on the stage;
distributing the thermally-curable optical material substantially uniformly over the substrate;
directing, via the ultrafast laser, radiation having a wavelength in the range 800 nm-2000 nm to the substrate;
solidifying at least a first portion of the thermally-curable optical material to generate a cured layer.

15. The method of claim 14, further comprising the step of cleaning off a liquid second portion of thermally-curable optical material from the position on the stage.

16. The method of claim 14, further comprising the step of:
dispensing additional thermally-curable optical material on the substrate; and
filling one or more gaps in the cured layer with the additional thermally curable optical material.

17. The method of claim 16, further comprising the step of heating the additional thermally-curable optical material on the substrate.

18. The method of claim 14, wherein the thermally-curable optical material is silicone.

19. The method of claim 14, wherein the cured layer is a flexible layer of a contact lens.

20. The method of claim 14, further comprising the step of programming at least one processor coupled to at least one of the stage, the dispenser and the laser, to control at least one of a position on the substrate on the stage at which the thermally-curable optical material is to be deposited.
